(19) United States
(12) Patent Application Publication
(10) Pub. No.: US 2008/0000960 A1
(43) Pub. Date: Jan. 3, 2008

(54) Method and apparatus for reliably marking goods using traceable markers

(76) Inventors: Christopher Scott Outwater, Santa Barbara, CA (US); William Gibbens Redmann, Glendale, CA (US)

Correspondence Address: WILLIAM G. REDMANN, 1202 PRINCETON DR., GLENDALE, CA, 91205, US

(21) Appl. No.: 11/805,445

(22) Filed: May 23, 2007

Related U.S. Application Data
(60) Provisional application No. 60/814,440, filed on Jun. 16, 2006.

(51) Int. Cl. G06F 17/00; G06Q 30/00

(52) U.S. Cl. 235/375; 235/385

(57) ABSTRACT

An apparatus and method are disclosed for verifying the contents of a package, including cartons, pallets, and containerized cargo. The verification is based on a barcode, RFID, or other identification detectable on the package, and an inexpensive mark having a covert or subtle properties that is machine-readable. The properties are stored in a database and are accessed with reference to the package identification.

### CROSS REFERENCE TO RELATED APPLICATIONS

This non-provisional patent application claims the benefit under 35 USC 119(e) of the like-named provisional application No. 60/814,440 filed with the USPTO on Jun. 16, 2006.

### FIELD OF THE INVENTION

The invention relates generally to a product authentication system and method and, more particularly, a product authentication system and method in which an authentication or security mark has a specific, predetermined, machine-detectable property corresponding to a second mark or tag, whereby the second mark or tag is confirmed.

### STATEMENT REGARDING FEDERALLY SPONSORED RESEARCH OR DEVELOPMENT

Not Applicable

### REFERENCE TO MICROFICE APPENDIX

Not Applicable

### BACKGROUND OF THE INVENTION

Various techniques have been used to identify articles in an effort to reduce counterfeiting. For collectibles such as art works and sports memorabilia, where a single item may be worth millions of dollars, a technique that is highly refined and virtually impossible to copy is desired. This is because high potential counterfeiting gains will motivate counterfeiters to invest large sums of money and resources to defeat the anti-counterfeit measure. Similarly, the high cost of implementing an anticounterfeiting measure for collectibles is typically accepted by the owner or insurer, because the potential loss from counterfeiting is great.

On the other hand, for mass produced items such as apparel, CDs, and audio and video cassettes, cost is a more important factor in implementing an anti-counterfeit measure. The implementation cost must be small enough so that the cost of the protected product will not increase dramatically. Yet, the anti-counterfeit measure must be refined enough so that counterfeiters will be unable to defeat the anti-counterfeit measure in a sufficiently easy manner such that they will be able to economically produce and sell counterfeit goods.

Mass produced items also have to be protected against product diversion. Product diversion occurs when a counterfeiter acquires genuine, non-counterfeit goods that are targeted for one market and sells them in a different market. The counterfeiter does this to circumvent the manufacturer's goal of controlling the supply of his or her goods in a particular market and, as a consequence, benefits from the sales in that limited supply market or in the diverted sales market.

In one type of anti-counterfeit and anti-diversion measure, an ultraviolet (UV) ink is used to mark the product with identifying indicia. One benefit of using the UV ink is that it is typically not visible when illuminated with light in the visible spectrum (380-770 nm), but is visible when illuminated with light in the UV spectrum (200-380 nm). Therefore, counterfeiters will be unable to tell whether the product contains a security mark by merely looking at the product when the product is illuminated with visible light.

A number of UV inks are readily available in the security industry and can be obtained at a relatively low cost. Several UV ink types and compositions are described, for example, in U.S. Pat. No. 5,569,317, entitled “Fluorescent and Phosphorescent Tagged Ink for Indicia” the disclosure of which is incorporated by reference herein. This patent discloses a security mark that becomes visible when illuminated with UV light having a wavelength of 254 nm.

However, the use of security marks containing a UV ink has seen increased use and counterfeiters have become knowledgeable about their use. It has been a common practice for counterfeiters to examine the UV ink from a product sample, reproduce or procure the same or similar UV ink that matches the characteristics of the UV ink from the product sample, and apply the same security mark on the counterfeit products using the substitute UV ink.

In another type of anti-counterfeit and anti-diversion measure, an infrared (IR) ink is used to mark the product with an identifying indicia. As with the UV ink, one benefit of using the IR ink is that it is typically not visible when illuminated with light in the visible spectrum, but is visible when illuminated with light in the IR spectrum (800-1600 nm). An additional benefit of using the IR ink is that it is more difficult to reproduce or procure the matching IR ink by studying a product sample containing the IR security mark. Examples of IR security mark usage are given in U.S. Pat. Nos. 5,611,958 and 5,766,324.

Widespread use of IR security marks has been limited, however, because of cost. Up-converting phosphors that are contained in IR inks are generally more expensive and less readily available than down-converting phosphors that are contained in many UV inks.

Combination security marks have also been proposed. In U.S. Pat. No. 6,12,494, a security mark containing two different types of phosphors is proposed. A barcode that is printed using invisible ink or over an area printed in secure ink has also been proposed by the inventor in U.S. Pat. No. 6,203,069.

### OBJECTS AND SUMMARY OF THE INVENTION

Containerized cargo, palletized shipments, and individual cartons of products are, in a simplified view, a hierarchy of nested containers typical of how goods are shipped throughout the industrial world.

Given modern security and product counterfeiting concerns, it is valuable to mark individual items in a manner that permits their authenticity to be determined. It is additionally valuable to be able to mark a container of such items in a way that permits an examination of the container and a check of the tags of one or a few items to corroborate the authenticity of overall contents.

Further, given the large number of items that are to be so marked, it is extremely valuable for the marking of such items to be extremely inexpensive, yet overall, the process of identifying shipments and contents should be quick and largely automatic.

It is an object of the present invention to provide a low cost, preferably covert, mark for items in a container, and to separately provide a traceable identification for the container, such that the container's contents can be readily verified. It is a further object of the present invention for the authenticity of association between a container so identified and an item so marked, to be available to equipment used for verifying the authenticity of a container's contents.

It is further an object of the present invention to provide authentication equipment able to be used with various marking technologies, whether covert or not.

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a detailed block diagram of a content verification station showing a packaging station and an inspection station;

FIG. 2 is a detailed block diagram showing an alternative packing station;

FIG. 3 is a detailed block diagram of a nested package making use of the present invention;

FIG. 4 is a flowchart for a packaging method corresponding to FIG. 1;

FIG. 5 is a flowchart for a packaging method corresponding to FIG. 2;

FIG. 6 is a flowchart for a method of nesting a package;

FIG. 7 is a flowchart for a package verification method;

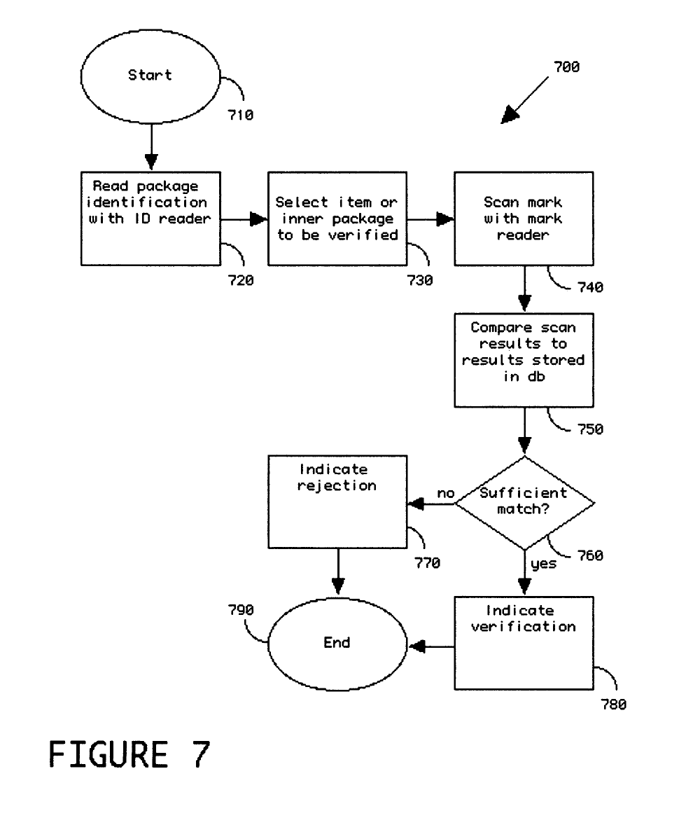

FIG. 8 is a flowchart for a challenge-based verification process;

FIG. 9 shows a block diagram of an optical sensor and mark usable to practice the present invention, and graphs of exemplary optical properties and their application; and,

FIG. 10 is a block diagram of a chemical sensor and mark usable to practice the present invention, and graphs of exemplary sensor readings.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

Various additional modifications of the described embodiments of the invention specifically illustrated and described herein will be apparent to those skilled in the art, particularly in light of the teachings of this invention. It is intended that the invention cover all modifications and embodiments which fall within the spirit and scope of the invention. Thus, while preferred embodiments of the present invention have been disclosed, it will be appreciated that it is not limited thereto but may be otherwise embodied within the scope of the following claims.

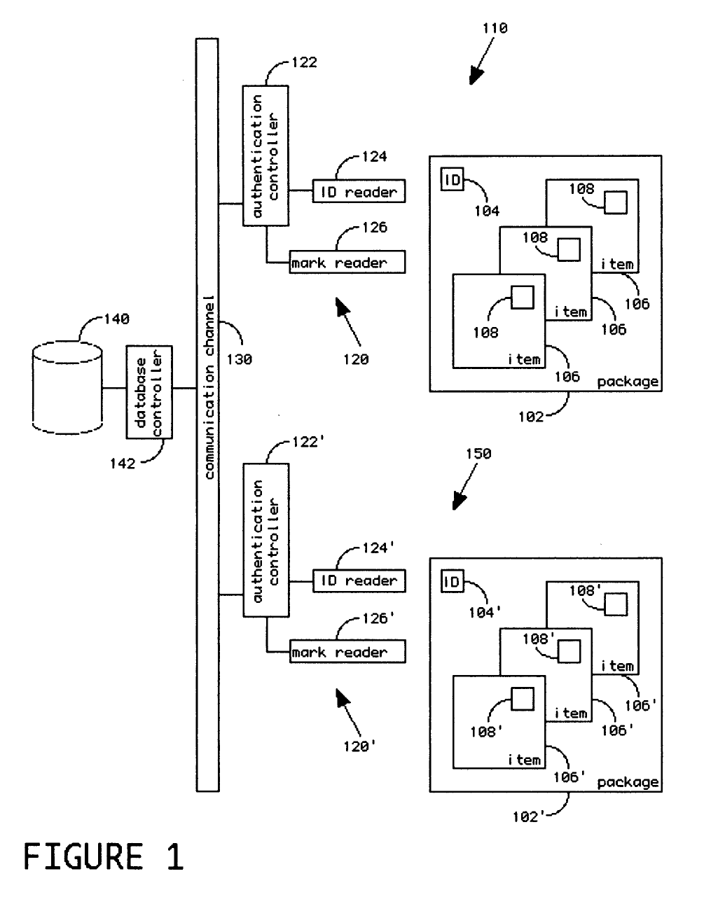

Referring to FIG. 1, a package 102 contains items 106. Items may be watches, articles of clothing, DVDs, computer software (e.g., CD- or DVD-ROMS), purses, pharmaceuticals, etc. In general, items 106 may be anything that is prone to counterfeiting or shipments prone to pilferage.

Items 106 are preferably pre-packaged in single stock keeping unit (SKU) packages or containers (not shown), but this is not required to practice the present invention. In particular, articles of clothing would be less likely as candidates for containers.

Package 102, contains multiple items 106, whether or not items 106 are pre-packaged.

At verified packing area 110, items 106 and package 102 are associated through identifier 104 and authentication marks 108 with each of items 106.

Identifier 104 can be a barcode, an RFID, a printed shipment number or invoice number, or other identification that preferably provides unique identification for each such package 102. However, it is adequate for the successful practice of the present invention that identification in a given identifier 104 merely be different from other packages having a substantially different era. For example, if package 102 is being packed in a factory in China, and the resulting shipment will be received in the United States two months later, a change in the uniqueness of the identification on the order of one week or even two, can allow successful practice of the present invention. Still, a shorter time between changes of identification is preferable.

Authentication equipment 120 comprises an ID reader 124 able to read the identification from identifier 104. For example, if identifier 104 is an RFID, then ID reader 124 is an RFID interrogator. If identifier 104 is a barcode, then ID reader 124 is a barcode scanner.

Identifier 104 could be a printed, human readable label, as with a shipping label or invoice, in which case ID reader would be a optical character recognition (OCR) scanner, or such an identifier could be read by a human operator and keyed into a keypad (not shown) to fulfill the role of ID reader 124.

Authentication equipment 120 further comprises mark reader 126 which is able to read authentication marks 108. Authentication marks 108 may be inherent in item 106, or may be printed onto each item 106.

An example of an inherent authentication mark 108, if item 106 were a garment, would be special threads, such as those described in U.S. Pat. Nos. 4,897,300 and 6,068,895 woven into the fabric of a garment collar tag. For such a mark, mark reader 126 comprises an exciter source and photodetector for sensing the materials in the fibers.

An example of a printed authentication mark 108, if item 106 were a collectable trading card would be invisible ink, perhaps printed in the form of a barcode, such as described in U.S. Pat. No. 6,203,069, printed directly onto the card itself.

If item 106 were pre-packaged, the printed mark 108 could be inherent to or printed on the pre-packaging material (not shown).

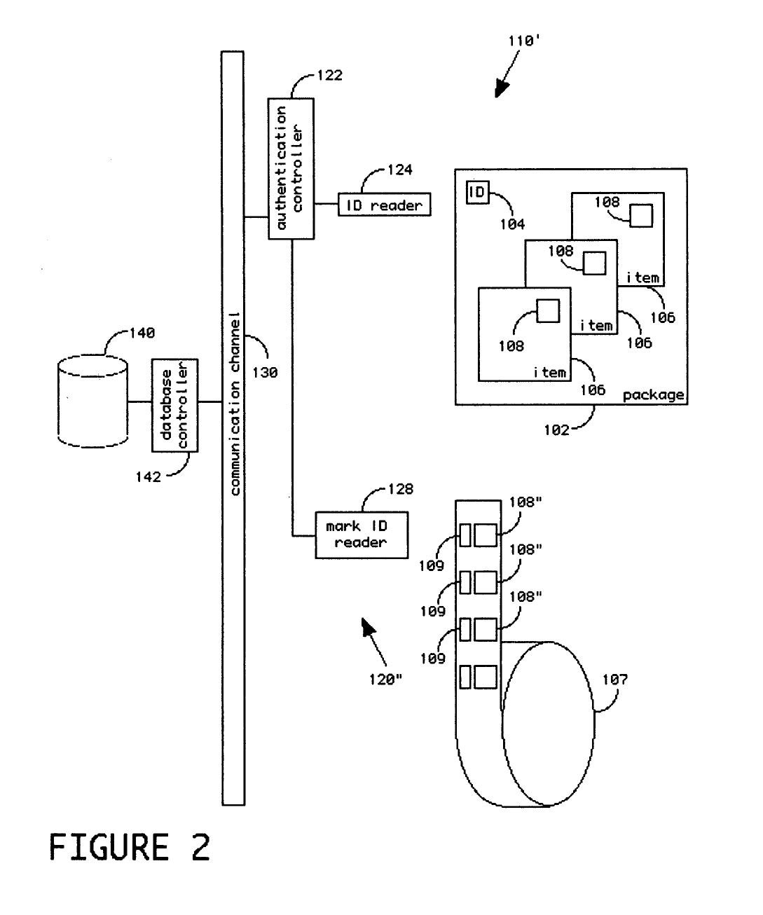

Alternatively, authentication mark 108 may be attached to item 106. For garments, an attached authentication mark 108 may be a tag that is pinned, tied, or stapled to the garment. Another attached authentication mark 108 would be a sticker, adhered during the manufacture of item 108, or during pre-packaging (if present), or as discussed below in conjunction with FIG. 2.

Authentication mark 108 has properties which are preferably not easily observed in an unaided inspection, and which are machine-readable with mark reader 126.

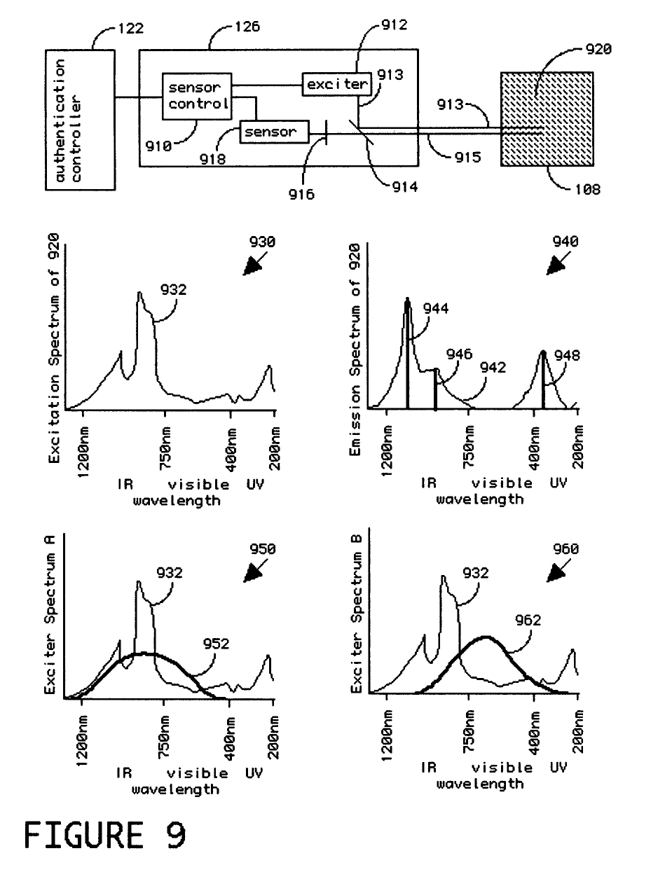

For example, if authentication mark 108 comprises an up-converting phosphor combination of U.S. Pat. No. 6,612,494, then the mark is not visible to an unaided observer, and even with a UV or IR light source, a particular ratio of combined phosphors is not likely to be discernable by an observer of median skill. Only with a spectrofluorometer (an instrument which measures fluorescent properties of compounds in order to provide information regarding their concentration in a sample) would the combination of phosphors be discernable, in which case, mark reader 126 would comprise such a device (as discussed below in conjunction with FIG. 9).

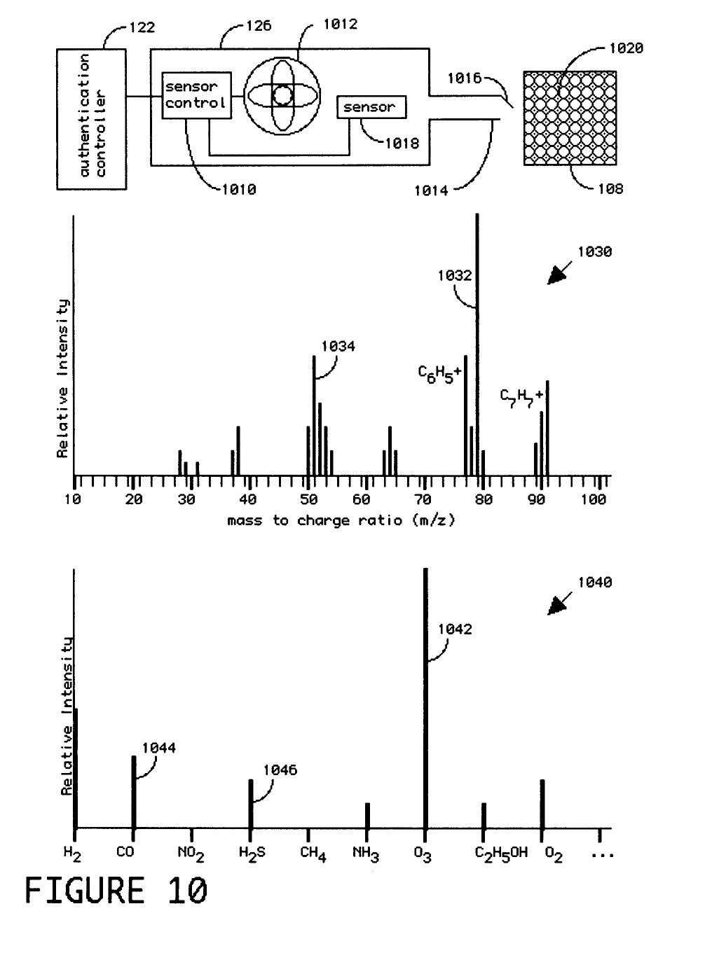

In another embodiment, authentication mark 108 comprise an aromatic chemical mixture micro-encapsulated in gelatin or plastic, such as those provided by Print-A-Scent, Inc., of Chattanooga, Tenn. A specific aromatic mixture will produce a repeatable assortment of volatile compounds that are emitted into the air when the surface of the authentication mark 108 is scratched or heated. The ratios of these volatile compounds will be sufficiently similar for a given mixture that they can be profiled by using a mark reader 126 comprising an “electronic nose” such as a gas chromatograph, mass spectrometer, or one or more semiconductor-based molecular sensors to capture a template against which later measurements of other marks can be compared to detect a match or non-match. This is discussed below in conjunction with FIG. 10.

Use of a precision color, highly stable ink (not shown) as the authentication mark 108 and a spectrometer or other color sensor (not shown) as the mark reader 126, will provide a usable embodiment of a mark providing a machine-readable property. Even though the key property of the mark (it's color) is perceivable by the unaided observer, the precision of the color as measured by the mark reader 126 will introduce a valuable delay of those attempting to counterfeit the mark.

Still other embodiments of the machine-readable authentication mark 108 and mark reader 126 will be recognized by those skilled in the art. Such alternative embodiments do not depart from the scope and spirit of the present invention.

At verified packing area 110, authentication mark 108 is presented to mark reader 126. The identification from identifier 104 is read by ID reader 124. Both the identification from ID reader 124 and reading of the mark 108 by mark reader 126 are provided to authentication controller 122. In the context of verified packing area 110, authentication controller 122 causes an association between the identification and the reading of the mark to be recorded in database 140. Preferably, the storage of the association in conducted over a communication channel 130 by way of database controller 142.

Authentication controller 122 is a microcomputer based device well known in the art, requiring only enough computational power to communicate with the ID reader 124, mark reader 126, etc., and to handle the necessary protocols and queries and responses discussed in detail below.

Communication channel 130 may be an Internet connection, where authentication controller 122 and database controller 142 communicate via an Internet protocol such as TCP/IP. Other protocols well known in the art, or their like may be used instead or in addition.

Database controller 142 is preferably a secure web server class computer, able to support the queries and database interactions discussed below. Further, due to the large number of potential queries to this database, while it is discussed in the context of a single device, those skilled in the art will recognize a potential need for high performance, high transaction rate, highly reliable, and secure n-tier server architectures for implementing this component.

In an alternative embodiment, the communication channel may be a telephone network, wherein authentication controller 122 comprises a modem which is able to participate in a connection with a modem associated with database controller 142.

In still another embodiment, communication channel 130 may comprise multiple links, any or all of which may be wireless.

Inspection station 150 might be a waypoint station (for example, customs or a port of entry) or a receiving station. Inspection station 150 comprises authentication equipment 120′, which is substantially similar to authentication equipment 120, comprising authentication controller 122′, ID reader 124′, and mark reader 126′. Inspection station 150 receives a package to be verified 102′.

The identifier 104′ of the package to be verified 102′ is read by ID reader 124′. At least one authentication mark 108′ needs to be read by mark reader 126′. The reading of mark 108′ and the identification read by ID reader 124′ are provided to authentication controller 122′.

Authentication controller 122′ calls database controller 142 through communication channel 130 for a query against database 140. The query is to determine whether an association has already been entered relative to the identification, and if so, whether the reading of mark 108′ represents an adequate match to the reading referenced in that association. If so, authentication controller 122′ can provide indication that items 106′ are authentic. If either no association exists for the identification, or if the reading of the mark is not a substantial match to the reading stored, then authentication controller 122′ indicates that item 106′ is not authentic.

Referring now to FIG. 2, verified packing area 110′ represents an alternative embodiment. Here, an authentication mark 108 is applied to each item 106. The applied authentication mark 108 is transferred from bulk supply 107 of authentication marks. Preferably, each authentication mark 108″ in bulk supply 107 is associated with a mark ID 109. Authentication equipment 120″ comprises a mark ID reader 128 that is configured to read mark ID 109, and provide the mark ID reading to authentication controller 122.

The properties of each authentication mark 108″ in bulk supply 107 have been predetermined, and have been stored in database 140 in association with the value obtained by reading mark ID 109. Using the principles of reading authentication mark properties discussed in conjunction with FIG. 1 and below, the pertinent properties of authentication mark 108″ can be captured anytime before the time bulk supply 107 is used. Each such mark 108″ is associated with a mark ID 109, which is preferably a barcode.

In an alternative embodiment, a single mark ID 109 that applies to many authentication marks 108″ a bulk supply 107 before another mark ID 109 is encountered.

An extreme embodiment is a single mark ID 109 for an entire bulk supply 107, the single mark ID being associated in database 140 with the properties of every authentication mark 108″ in bulk supply 107.

It is important to note that while preferable, it is not necessary that all authentication marks 108 within a package 102 have substantially the same properties. Nor is it required in a bulk supply 107 having a single mark ID 109 that all authentication marks 108″ have substantially the same properties. In both cases, it is only necessary that the properties of each authentication marks 108 and 108″ are associated with the identification of identifier 104 and mark ID 109, respectively. It is allowable for more than one reading of authentication mark properties to have an association in database 140 with a particular identification from identifier 104 or with a particular mark ID 109, provided that each association accurately represents authentication marks co-resident in a package 102 or bulk supply 107.

Still, it is preferable to keep small the number of distinct but differing readings of authentication mark properties associated with a single mark ID 109 or a single identification from identifier 104. The reason is that each additional association improves the chances of a counterfeiter guessing by chance a corresponding set of authentication mark properties for a specific identification.

Database 140 stores the linkage between the measurable properties of authentication mark 108″, and mark. ID 109. A new linkage between mark ID 109 and the identification from identifier 104 provides an effective association between the properties of mark 108″ and the identification from identifier 104, whether or not actualized at the time the latter record is created, or at the time of the query from inspection station 150.

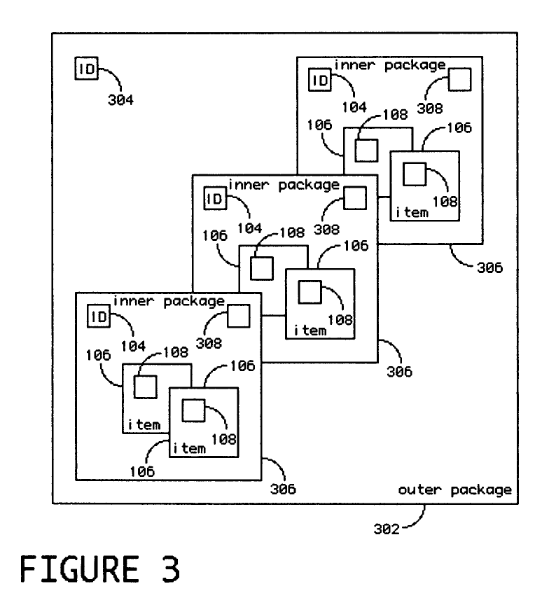

The versatility of database 140 enables another embodiment of this invention, as shown in FIG. 3, wherein one or more items 106 each having authentication marks 108 are collected in package 306 identified by identifier 104, the identification of which is stored in association with the authentication marks 108 in database 140, as previously described.

However, package 306 is then treated in the manner that the items were treated. Each package 306 has its own authentication mark 308, this mark having its own properties which are preferably different than authentication mark 108. Package 306 is placed into a larger package 302, such that package 306 is an inner package, and package 302 is an outer package. Outer package 302 has an identifier 304, which can be embodied with as much versatility as previously described for identifier 104.

As with identifier 104 and authentication mark 108, the identification from identifier 304 and the properties read from authentication mark are related in database 140. The result being a nested relationship that provides validation of items 106 or inner packages 306 by reading from any of package identifiers 104 and 304.

An example of such nesting would be items in cartons on a pallet, where items 106 are in carton 306, which are collected on pallet 302.

Or, in another embodiment, cartons 106 are on pallets 306, which are in containerized cargo unit 302.

As will clear to those skilled in the art, this principle of nesting packages and chaining of verifications is not limited to just these two levels, the marks and identification of cartons of items on pallets in cargo containers can all be hierarchically related in database 140.

It will also be apparent to those skilled in the art that database 140 can be consolidated as shown, or it can be distributed (not shown). For instance, assembling inner packages 306 (e.g., cartons or pallets) might occur at one verified packing station 110, but outer packages 302 (pallets or cargo containers, respectively) can be assembled at a distinct verified packing area 110, which may be physically at a different scale, as packing cartons and packing pallets or cargo containers require very different scales of handling equipment. Note too, that authentication equipment 120 may also vary with scale. A the scale of a carton, a reasonable choice for identifier 104 is a barcode and ID reader 124 can comprise a handheld barcode scanner. However, at the scale of a cargo container, identifier 104 can comprise an active RFID tag and ID reader 124 can comprise an RFID interrogator having a range of 30 feet, or more.

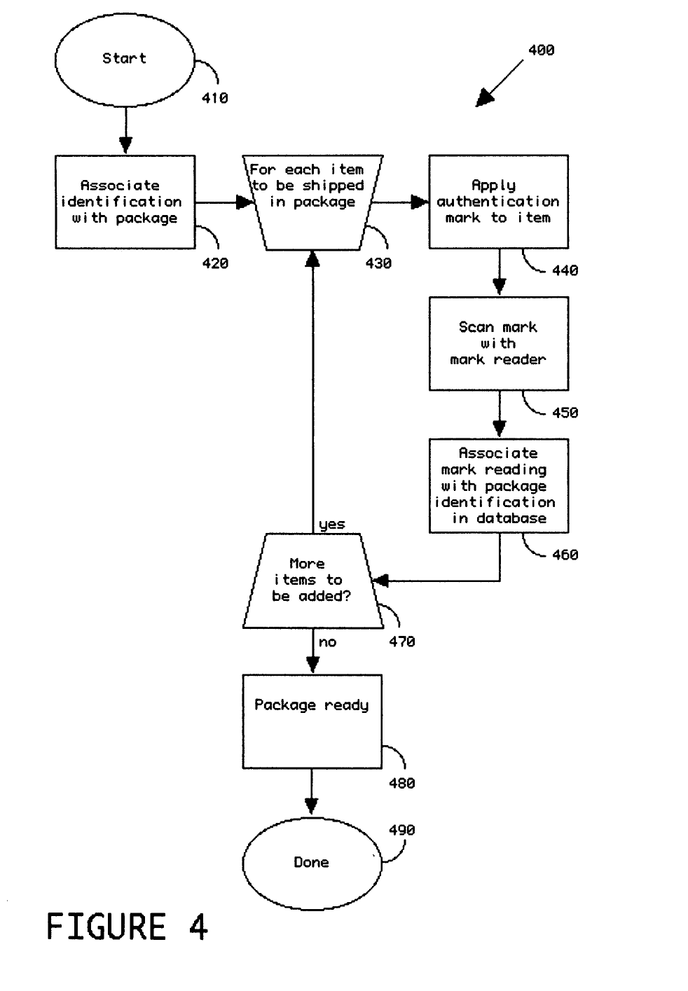

The verified packing method 400 used to operate verified packing area 110 is shown in FIG. 4. By way of example, identifier 104 is presumed to be an RFID and mark 106 is presumed to comprise a covert pigment having a particular formulation and measurable properties. However, those skilled in the art will recognize that any of the alternative embodiments for identifier 104 and mark 106 may be substituted with the appropriate changes, without departing from the present invention.

At the start 410, package 102 is an empty container, whether a bag, can, drum, carton, pallet, or other container, including larger scale containers.

The package 102 is associated with an identification readable from identifier 104 in package identification step 420. At this time, identifier 104, an RFID tag in this example, is physically added to package 102, preferably on the inside, and preferably affixed to the package itself.

In the alternative, identifier can be affixed to the outside of the package 104.

Identifier 104 is preferably pre-configured with an identification, which is read in this step by ID reader 124.

In the alternative, the identification is created dynamically and identifier 104 is written to by ID reader 124, at this time. For example, if identifier 104 comprises a barcode, then authentication equipment 120 can comprise a printer (not shown) for creating that barcode. Dynamic identification creation can invoke a query to database server 142, or execute a procedure in authentication controller 122. Algorithms and methods for generating a globally unique identification (GUID) on demand are well known to those skilled in the art.

In another alternative embodiment, the shipper number, or transaction number associated with the package can be used for the identification. However, it is generally less desirable for the same identification to be used for large numbers of packages, especially if they will be in transit or warehoused for long periods of time, during which a counterfeiting operation might have sufficient time to examine a package/authentication mark combination for duplication.

Such dynamically retrieved or created identification is not limited to printed identifiers. Identifier 104 can comprise an RFID that is written by authentication equipment 120 using an RFID programmer (not shown).

Those skilled in the art will readily recognize other mechanisms for imbuing identifier 104 with an identification, and that these mechanisms can be employed to carry out the processes discussed here in associated with verified packing area 110.

Iteration step 430 begins a loop which is iterated for each item 106 to be verified and associated with the package 102.

In mark application step 440, an authentication mark 108 is applied to the current item 106. In the preferred embodiment, the authentication mark 108 can be applied directly onto the surface of item 106, or its unit packaging.

An alternative embodiment is to attach a pre-manufactured authentication mark onto item 106, or its unit packaging. For example, authentication mark can comprise a pre-manufactured tag having a machine-readable marking (e.g., a UV-barcode or precision color swatch), and this tag can be pinned, stapled, or sewn, etc., to an item 106 comprising, a garment. Alternatively, item 106 may comprise a unit of goods in a shrink-wrapped box ready for retail presentation, and authentication mark 108 can comprise a sticker bearing a suitable machine-readable marking or property, the sticker being adhered to item 106 during the application step 440.

In scan step 450, the mark 108 applied to item 106 in step 440 is scanned with mark reader 126, and the reading returned from mark reader 126 are provided to authentication controller 122.

In readout step 460, the return from mark reader 126 is associated with the identification associated with package 102 in step 420. Preferably, the association is stored securely in database 140.

If this association between the mark reader 126 results and the identification is substantially duplicative, that is, if for the particular identification, there is already a substantially similar mark reader 126 result, then no additional entry into database 140 is required.

In an alternative embodiment, however, a count associated with the relationship is incremented. In this way, no only is there a record of authentication mark 108 on an item in package 102, but also a count of how many like-marked items there are.

In completion check step 470, a check is made to determine if any further items 106 are to be included in package 102. If so, the process loops back to step 430. If no items remain to be added to package 460, the process continues at step 480.

In sealing step 480, the package is complete and is preferably sealed before leaving the verified packing area 110.

At end 490, the packing process is finished.

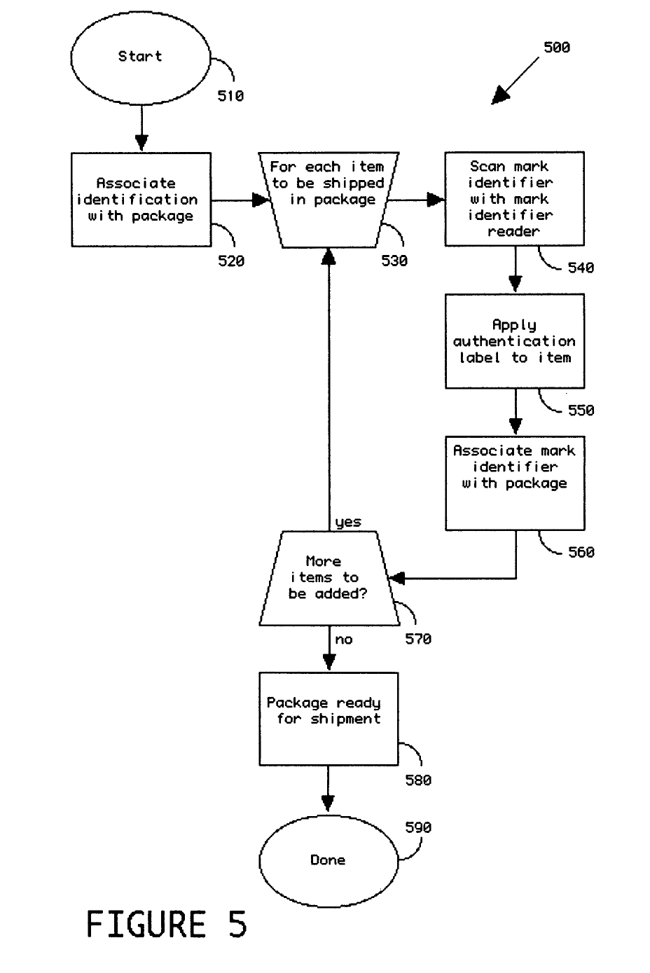

Alternative packing process 500, shown in FIG. 5, is shares many elements with packing process 400, but employs the verified packing area 110′ and authentication equipment 120″.

Start 510, package identification step 520, iteration step 530, completion check step 570, sealing step 480, and end 490 are the same as the corresponding steps 410, 420, 430, 470, 480, and 490.

In mark identification step 540, mark ID reader 128 is used to scan mark ID 109 associated with authentication mark 109′ from bulk supply 107. The resulting mark ID is provided to authentication controller 122.

In application step 550, authentication mark 108″ is transferred from bulk supply 107 and attached to item 106, and item 106 is added to package 102.

The mark ID obtained in mark identification step 540 associates the properties of the corresponding authentication mark 108 (prior to application step 550, authentication mark 108″) with package 102. In association step 560, the mark ID or the properties of the corresponding mark 108 are associated with the identification associated with package 102 in step 520. These associations are preferably sent by authentication controller 122 via communication channel 130 and stored in database 140.

Preferably, the properties of authentication mark 108″ were previously stored in database 140 in an association with mark ID 109. In this manner, the actual properties of authentication mark 108 can remain hidden during the execution of packing process 500.

Upon conclusion of either packing process 400 or 500, the result is fundamentally the same: package 102 contains a number of items 106, each marked with an authentication mark 108 for which certain properties, preferably machine-readable, and preferably covert, are stored in database 140 in association with an identification carried by identifier 104 in or on package 102.

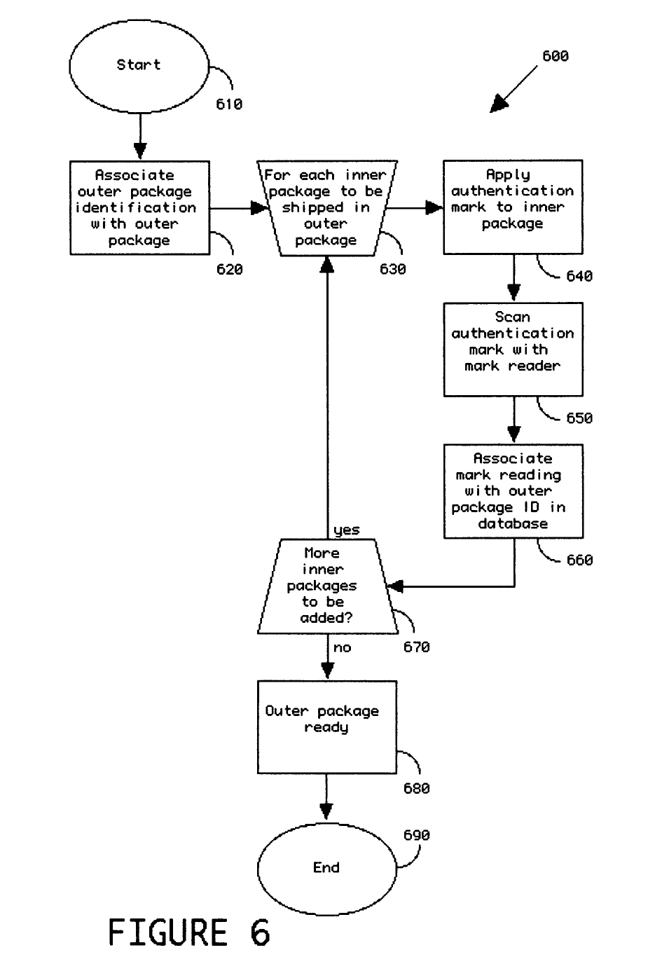

Nested packaging process 600 is shown in FIG. 6. At the start 610, an outer package is 302 is empty. In package identification step 620, the outer package 302 is provided with an identification in identifier 304.

Iteration step 630 repeats for each inner package 306 (prepared, for example by packaging process 400 or 500) to be introduced to the outer package.

Mark application step 640 associates an authentication mark 308 on the outside of inner package 306.

The authentication mark 308 is scanned by authentication equipment 120, more specifically, a mark reader 126, in scan step 650. The results from mark reader 126 are supplied to authentication controller 122.

In readout step 660, the properties of authentication mark 308 obtained from mark reader 126 are sent to database 140 by authentication controller 122, in conjunction with the identification in identifier 304 to record that relationship.

When a check for completion is made in step 670, if more inner packages 306 are destined to enter outer package 302, then the process loops to iteration step 630. However, if no further inner packages 306 are to be included, outer package 302 is preferably sealed in step 680 before outer package 302 leaves verified packaging area 110. The nested packaging process concludes with end 690.

For an alternative embodiment of nested packaging process 600, readers will note that steps 640, 650, and 660 are analogous to steps 440, 450, and 460; and that use of a bulk supply 107 of authentication marks can be applied in process 600 by substituting appropriate analogs of steps 540, 550, and 560.

Given a package 102′ assembled according to the preceding description or an equivalent, a verification 700 can be conducted as follows:

The start 710 of verification requires a package 102′ allegedly prepared with one of the packing processes 400, 500, or 600, or the equivalent. The package 102′ should be at an inspection station 150 and authentication equipment 120′ must be available.

ID reader 124′ interrogates identifier 104′ in interrogation step 720 to retrieve the package identification, which is passed to authentication controller 122′.

In selection step 730, the package 102′ is opened and an item 106′ is selected for verification.

In an alternative embodiment, before package 106′ is opened, authentication controller 122′ could query database 140 through communication channel 130 and database controller 142 to determine if any records exist for the identification obtained in interrogation step 720. If no such records exist, package 106′ becomes suspect and no authentication can proceed. However, permitting such a query through database controller 142 may provide a counterfeiter with a tool to facilitate guessing valid identifications. This alternative embodiment should be used with a respect for the additional attendant security risks.

The authentication mark 108′ of the item 106′ selected in selection step 730 is scanned by ID reader 124′ in scan step 740. The results of the scan are provided to authentication controller 122′.

In query step 750, authentication controller 122′ submits the results of scan step 740 with the identification obtained in interrogation step 720 as a query to database controller 142, by way of communication channel 130.

Database 140 is searched for records associated with the identification submitted that match sufficiently with the results from the scan performed using mark reader 126′.

The determination of the sufficiency of a match is dependent on the specific authentication mark technology. Any physical measurement will include some noise, and estimating the amount of noise, or error, inherent in a measurement of a physical property is well known in the art.

Further, depending on the authentication mark technology used, aging and environmental effects may result in a variation or drift in the authentication mark's properties, which again can be estimated.

If the drift is predictable, as for example a radioactive decay relative to the passing of time, then the drift can be compensated for and a match determined with respect to the present expected value, rather than the value originally measured at the time of step 450.

If a variation is to be dependent on a history that was not recorded (e.g., ink fade resulting from cumulative UV exposure) then a sufficient match algorithm may take into account the variations that would result from all conditions between no and maximum likely UV exposure over the time intervening between execution of packing scan step 450 and the current scan step 740.

Some mark properties may depend on the immediate conditions (e.g., the current relative humidity, or temperature). When sensing properties so affected, mark reader 120′ (and 120, too) should employ auxiliary sensors to measure pertinent conditions (such as a hygrometer or thermometer, respectively, in the prior example).

Those skilled in the art will recognize the interplay of factors to be considered: the decision of which authentication mark technology to use requires consideration of a wide range of factors likely to be encountered in shipping and, when appropriate, long storage times, even the nature of the items themselves. Were apples to be the items subject to authentication, then certain chemical or aromatic-based authentication marks might be inappropriate choices, due to the chemical and aromatic environment created by apples themselves. Or, if the authentication mark technology were chosen anyway, then a determination of a sufficient match would need to take into account the perturbation that might be introduced by the apples.

If evaluation step 760 results in a finding, even accounting for all anticipated changes and errors, that there is no sufficiently matching record, then in rejection step 770, the item 108′ is considered non-verified.

However, if record representing a sufficient match is found, then item 108′ is proclaimed verified in step 780.

The verification process ends at 700, preferably without looping at all, since the package 102′, may be considered as a whole. If the item 106′ selected in selection step 730 was considered verified in step 780, then the entire contents of package 102′ may be considered verified.

In an alternative method, verification process 700 can be repeated for any number of items 106′ in package 102′, and this would be appropriate in a case for each individual item 106′ of high value.

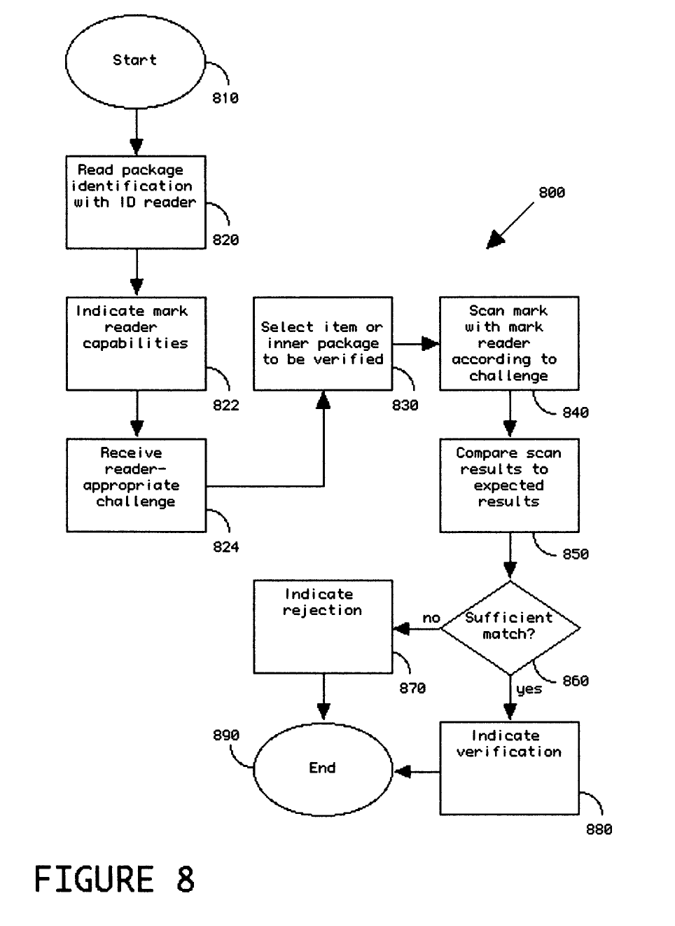

In FIG. 8, a more flexible process exhibiting a higher degree of security is shown: challenge/response verification process 800. Here, the database server 142 issues a challenge to the verification equipment 120′ as follows:

Start 810 and interrogation step 820 are identical to steps 710 and 720.

In capability step 822, identification of the package 102′ (from step 820) and the capabilities of mark reader 120′ are reported by authentication controller 122′ to database controller 142. If a variety of manufacturers make mark readers such as 120′, or a given manufacturer has multiple models of mark reader, a cost or performance advantage may come with a limitation or variation in measurement capability.

For example, a color sensor suitable for mark reader 126′ might make three measurements through different color filters. The specific sensitivity bands of the three sensors will influence the actual reading of a target color. However, in a packaging facility where the mark reader 126 is collecting data that will eventually be matched against the readings of many other heterogeneous devices, it is preferable to make a complete measurement of the authentication mark color with a spectrophotometer. Given the characteristics of a different measurement device (mark reader 126′), the anticipated reading can be computed from the authoritative reading from the superior mark reader 126. This particular example will resonate with colorists, who will be particularly familiar with the techniques involved in achieving similar color metrics from dissimilar sensor devices.

Ultimately, this results in allowing a larger number of competitively priced mark readers 126′ to be provided by competing manufacturers and used successfully in inspection stations 150.

Database controller 142 has received the package identification (from interrogation step 820) and a description of the capabilities of mark reader 126′.

In challenge step 824, database controller 142 can access all records stored under the identification of package 102′. From those records, database controller 142 computes one or more measurements which can be made by mark reader 126′ and the measurement results which are expected from an appropriate authentication mark 108′. Exemplary computations of this sort are described below in conjunction with FIGS. 9 & 10. The selected measurements (but preferably not the expected results), are communicated by database controller 142 to authentication controller 122′.

Selection step 830 is identical to step 730.

In challenge scan step 840, authentication controller 126′ communicates to mark reader 126′ the parameters of the selected measurements in the challenge from database controller 142. In cases where mark reader 126′ can only perform a specific measurement or measurements, no parameter passing is appropriate.

Mark reader 126′ performs the scan of authentication mark 108′, according to the parameters given, if applicable. The results of the scan are returned to the authentication controller 122′.

Query step 850 is similar to query step 750, but the scan results provided are the next step in a transaction with the database controller 142 that was begun in capability identification step 822. However, the database controller 142 ends up with the results of the scan.

In evaluation step 860, database controller 142 compares the scan results returned by mark reader 126′ to those that were anticipated (but not communicated) in challenge step 824. If multiple results were anticipated due to multiple readings for authentication marks 108 read in association with package 102′ when it was in verified packing station 110, then a comparison is made against each of those multiple readings, accounting for not only the drifts and perturbations discussed in conjunction with evaluation step 760, but also the variation expected due to the capabilities reported in capability identification step 822.

If the match is sufficient, considering the circumstances and limitations of the scanner, authenticity is verified in step 880. Otherwise, authenticity is rejected in step 870, and the process concludes with end 890.

This challenge/verification process offers additional security precautions over the simpler verification process. First, the totality of measurements pertinent to the authentication mark are never transmitted all at once. Even if may challenges and responses are intercepted or reproduced through experiments, there remains a chance for a challenge that wasn't anticipated, and the counterfeiter is foiled.

FIG. 9 shows a block diagram of a preferred embodiment of mark reader 126, based on optical sensing. Sensor control 910 triggers exciter 912 which emit light 913, which is directed by beamsplitter 914 to impinge on authentication mark 108. In this embodiment, authentication mark 108 comprises a coating 920 having predetermined optical properties, for example a specific up-converting phosphor.

If the light 913 from exciter 912 causes any backscatter or emission 915 from the coating 920, a portion passes through beamsplitter 914, through filter or grating 916, which may be selective about what frequencies arrive at sensor 918. The detection of emission or backscatter 915 from coating 920 produces a signal, which is provided to sensor control 910 for extraction (as with a phase sensitive amplification). The final result is provided to authentication controller 122.

Excitation spectrum 930 in FIG. 9 is a hypothetical excitation spectrum of coating 920. In particular, it shows a significant peak excitation 932 where the prescribed range of infra-red (IR) frequencies will provide efficient excitation of the phosphor.

Emission spectrum 940 shows the emission characteristics of coating 920. Three wavelengths are shown as particularly significant, 944 and 946 in the IR, and 948 in the near UV. There is also a spectral region of little emission, called out as 942.

Together, the excitation and emission spectra 930 and 940 represent the significant properties of authentication mark 108.

Each of charts 950 and 960 show a hypothetical broadband light source that can be produced by exciter 916. Band 952 is mostly IR and red light; while 962 is less IR and more yellow. The spectra representing these two curves 952 and 962 would be provided to the database controller 142 in capability identification step 822, as would the nature of filter or grating 916.

An example of the calculation that database controller 142 would perform to create the challenge is to note that excitation 952 would represent a strong excitation of peak 932, while excitation 962 would represent a lesser, but non-zero, excitation.

Given this information, the phosphor's overall emission would be greater if illuminated by the light from excitation 952, than from 962, and in fact, the dot-product of the each curves with the excitation spectrum of chart 930 would indicate the precise ratio of this difference.

Further, suppose that the filter 916 can be controlled by sensor control 910 to selectively admit the frequencies indicated in spectrum 940 by lines 944, 946, 942, and 948.

If the challenge were to contain only a single frequency, it would not be at 942, since the expected reading is nearly zero, which is the same result expected if there were no authentication mark 108′ present.

The frequency at line 944 would represent the strongest response, and would be the least noisy, for reasons of large signal. A good technique using different filters is to present two frequencies in the challenge: the readings at frequency 944 and 946 should show about a 3:1 amplitude ratio. An emission at the frequency of 948 is uncommon, given a primarily IR and red-yellow light, and if this is a key frequency signature of this phosphor, that reading may be distinctive.

Between four filter values 944, 946, 942, and 948 and two exciter spectra 952 and 962, this hypothetical mark reader 126 can make 8 distinct measurements. Some are not particularly useful in identifying coating 920 (e.g., filter frequency 942 is not reliable, since the response at that frequency can be simulated by not having a target. Others are more valuable (those having peak or unusual responses).

By switching exciter choices (952,962), a crude estimate of excitation graph 930 can be obtained, though to derive it in this manner would tell little more than coating 920 has an excitation peak in the IR. However, knowing that coating 920 has precisely the excitation spectrum 930 would allow a precise calculation of relative excitation.

A very different sensor is shown in FIG. 10, yet the principles of application to the problem being solved are the same.

In this case, authentication sensor 126 is an “electronic nose”, comprising (in an oversimplified description) sensor controller 1010, fan 1012 for producing airflow from the nozzle 1014 across the sensor module 1018.

Here, authentication mark 108 has an aromatic compound microencapsulated in coating 1020.

A scratching tip 1016 on nozzle 1014 is used to break the microcapsules in coating 1020, to release a tiny amount of aromatic material into the air.

When the sensor control 1010 activates, fan 1012 will draw up the aromatically tinged air through nozzle 1014 and over sensor 1018.

Depending on the implementation of the sensor, different results might be obtainable. A mass spectrometer's results for a hypothetical compound in coating 1020 might look like graph 1030. Clearly discerned peaks 1034 and 1032, likely representing two ionized species, would be clear candidates for measuring a ratio, assuming at least one of the two is relatively uncommon in the indicated concentration.

However, the preferred “electronic nose” sensor is semiconductor-based, as is for example, one using semiconducting organic polymers, as taught in U.S. Pat. No. 5,882,497.

Chart 1040 shows the nature of the readings from semiconductor-based noses. Individual sensors are coated and sensitized in such a way that each is sensitive to a particular molecular species, such as those listed along the horizontal axis of chart 1040. For a particular aromatic compound in coating 1020, dominant species 1042 (ozone) might be measured in ratio against species 1044 (carbon monoxide), or others.

Sensor control 1010 operates to establish a baseline measurement from sensor 1010 before authentication begins.

Various additional modifications of the described embodiments of the invention specifically illustrated and described herein will be apparent to those skilled in the art, particularly in light of the teachings of this invention. It is intended that the invention cover all modifications and embodiments which fall within the spirit and scope of the invention. Thus, while preferred embodiments of the present invention have been disclosed, it will be appreciated that it is not limited thereto but may be otherwise embodied within the scope of the following claims.

We claim as our invention:

1. A system for authenticating goods, said system comprising:
a data record representing an association between an identification and a first reading corresponding to a mark;
a package having an identifier bearing said identification;
an item having an instance of said mark;
authentication equipment comprising a first controller and a first reader,
said first reader able to read said instance of said mark and produce a second reading corresponding to the instance,
said authentication equipment having access to said data record and said second reading,
said authentication equipment being provided with said identification from said identifier,
said authentication equipment able to select said first reading from said data record with said identification from said identifier and to compare said second reading to said first reading, whereupon a substantial match authenticates said item.

2. The system of claim 1, wherein said authentication equipment further comprises a second reader able to read said identifier to provide said identification.

3. The system of claim 2, wherein said identifier comprises an RFID tag and said second reader comprises an RFID interrogator.

4. The system of claim 2, wherein said identifier comprises a barcode and said second reader comprises a barcode reader.

5. The system of claim 2, wherein said identifier comprises a printed label and said second reader comprises an OCR reader.

6. The system of claim 1, wherein said authentication equipment further comprises a keypad, said identifier comprises a human readable label, and said identification is provided through said keypad by an operator having access to the label.

7. The system of claim 1, wherein said identification is unique to said package.

8. The system of claim 1, wherein said identification is different when said package has a substantially different era.

9. The system of claim 1, wherein said mark comprises a barcode and said first reader comprises a barcode scanner.

10. The system of claim 1, wherein said mark is printed and said first reader comprises an OCR scanner.

11. The system of claim 1, wherein said mark is covert.

12. The system of claim 11, wherein said mark comprises a phosphor and said first reader comprises a spectrofluorometer.

13. The system of claim 11, wherein said mark comprises an aromatic chemical and said first reader comprises an electronic nose.

14. The system of claim 1, wherein said mark comprises a color and said first reader comprises a color sensor.

15. The system of claim 1, further comprising
a secure database for storing said data record; and,
a communication channel, said authentication equipment having access to said secure database through said communication channel.

16. The system of claim 15, further comprising
a second controller and a second reader able to read said mark to produce said first reading,
said second controller being provided with said identification,
said second controller creating said data record in database.

17. The system of claim 15, further comprising
a second controller and a second reader able to read said instance of said mark to produce said first reading,
said second controller able to generate said identification,
said second controller creating said data record in database.

18. The system of claim 17, wherein said second controller writes said identification to said identifier.

19. The system of claim 18, wherein said identifier is an RFID tag and said second controller comprises an RFID programmer, and wherein said second controller writes said identification to said identifier with said RFID programmer.

20. The system of claim 18, wherein said second controller comprises a printer and said identifier is printed, and wherein said second controller writes said identification to said identifier with said printer.

21. The system of claim 1, wherein said substantial match accounts for at least one selected from the group of aging, environmental effects, and immediate conditions.

22. A method for authenticating goods, said method comprising the steps of:
a) providing a database;
b) physically associating an identifier with a container, said identifier having an identification;
c) applying a mark to an item;
d) reading said mark with a first reader to produce a first reading;
e) storing a data record in said database to associate said identification with said first reading;
f) packing said item in said container;
g) reading said mark with a second reader to produce a second reading;
h) retrieving said data record from said database with said identification; and,
i) comparing said first reading to said second reading;
whereby a substantial match in step i) indicates the authenticity of said item.
